(19) United States
(12) Patent Application Publication
(10) Pub. No.: US 2013/0138321 A1
(43) Pub. Date: May 30, 2013

(54) VEHICLE'S TRAVEL STATE DETERMINATION APPARATUS, VEHICLE'S TRAVEL STATE DETERMINATION METHOD AND NON-TRANSITORY COMPUTER-READABLE STORAGE MEDIUM

(71) Applicants: Akemi Toyoda, Toyota-shi (JP); Tomohiko Endo, Toyota-shi (JP)

(72) Inventors: Akemi Toyoda, Toyota-shi (JP); Tomohiko Endo, Toyota-shi (JP)

(21) Appl. No.: 13/687,864

(22) Filed: Nov. 28, 2012

(30) Foreign Application Priority Data
Nov. 29, 2011 (JP) 2011-260815

(51) Int. Cl. G06F 17/00

(52) U.S. Cl. CPC G06F 17/00
USPC 701/99

(57) ABSTRACT

A vehicle's travel state determination apparatus includes a vehicle speed detection portion that detects speed of the vehicle and outputs speed information; a threshold value output portion that outputs a threshold value based on the speed information; a power source stop detection portion that detects a stop of a power source of the vehicle and outputs power source stop information; and a travel state determination portion that determines a travel state of the vehicle based on the power source stop information and the threshold value. The travel state determination portion determines the travel state of the vehicle on the basis of the threshold value and the elapsed time that follows output of the power source stop information.

### INCORPORATION BY REFERENCE

The disclosure of Japanese Patent Application No. 2011-260815 filed on Nov. 29, 2011 including the specification, drawings and abstract is incorporated herein by reference in its entirety.

### BACKGROUND OF THE INVENTION

1. Field of the Invention

The invention relates to a vehicle's travel state determination apparatus, vehicle's travel state determination method and a non-transitory computer-readable storage medium that are suitable to be applied to passenger automobiles, trucks, busses, etc.

2. Description of the Related Art

In recent years, on the assumption of possibility of occurrence of an inconvenience while a vehicle is traveling, the stopping of the engine of a vehicle during the traveling of the vehicle is being considered. In particular, with regard to vehicles in which the starting and stopping of the engine is performed by pressing a push switch, the SAE standards recommend that if the engine of a vehicle is stopped during the traveling of the vehicle due to occurrence of an inconvenience as mentioned above, or due to the driver's inadvertent operation without occurrence of an inconvenience, the restarting of the engine should be immediately prompted during the traveling.

It is desirable that a message that prompts the restarting of the engine as described above be presented to the driver of the vehicle while the vehicle is traveling. To that end, there is a need to determine whether the vehicle is traveling with the engine stopped. For example, in a technology described in Japanese Patent Application Publication No. 2009-083530 (JP 2009-083530 A), an electronic control unit (ECU) in a vehicle computes the vehicle speed on the basis of signals from wheel speed sensors. However, when the engine is in a stopped state, that is, when a switch for supplying electric power to appliances provided in the vehicle is in an accessory state (ACC state), the ECU is not supplied with power, and therefore cannot acquire (cannot detect or estimate) the vehicle speed.

That is, in a system as described in JP 2009-083530 A, if while a vehicle is traveling, the engine is stopped and the power supply system enters the ACC state, the vehicle speed cannot be acquired, so that it cannot be determined whether the vehicle is traveling and, therefore, it is difficult to appropriately produce a message as mentioned above that prompts the driver to restart the engine during the traveling of the vehicle.

### SUMMARY OF THE INVENTION

The invention provides a vehicle's travel state determination apparatus, a vehicle's travel state determination method and a non-transitory computer-readable storage medium which are capable of immediately prompting the restarting of the engine of the vehicle if the engine stops while the vehicle is traveling.

A first aspect of the invention is a vehicle's travel state determination apparatus that includes: a vehicle speed detection portion that detects speed of the vehicle and outputs speed information; a threshold value output portion that outputs a threshold value based on the speed information; a power source stop detection portion that detects a stop of a power source of the vehicle and outputs power source stop information; and a travel state determination portion that determines a travel state of the vehicle based on the power source stop information and the threshold value, wherein the travel state of the vehicle is determined based on the threshold value and an elapsed time that follows output of the power source stop information.

In the foregoing first aspect, the vehicle's travel state determination apparatus may further include a braking determination portion that determines whether braking is being performed in the vehicle, and if it is determined by the braking determination portion that the braking is not being performed, the threshold value output portion may compute the threshold value based on a deceleration that is assumed to be minimum regarding the vehicle.

In the first aspect, the vehicle's travel state determination apparatus may further include a braking determination portion that determines whether braking is being performed in the vehicle, and if it is determined by the braking determination portion that the braking is being performed, the threshold value output portion may compute the threshold value based on a deceleration that is assumed to be maximum regarding the vehicle.

In the first aspect, the vehicle's travel state determination apparatus may further include a decelerating state detection portion that detects a decelerating state of the vehicle, and the threshold value output portion may output the threshold value that is based on the speed information and a deceleration that corresponds to the decelerating state.

In the first aspect, the decelerating state detection portion may compute the threshold value so that the threshold value decreases as the deceleration increases, and may output the threshold.

Furthermore, in the first aspect, the vehicle's travel state determination apparatus may further include a display portion that displays a content that prompts restarting of the power source, if it is determined by the travel state determination portion that the vehicle is traveling.

A second aspect of the invention is a vehicle's travel state determination method that includes: detecting speed of the vehicle; outputting a threshold value based on the speed; detecting that a power source of the vehicle is in a stopped state; and performing travel state determination as to whether the vehicle is traveling, based on the threshold value and an elapsed time that follows a time point at which the stopped state of the power source is detected.

In the second aspect, the vehicle's travel state determination method may further include displaying how to start the power source, if it is determined that the vehicle is traveling. Furthermore, a third aspect of the invention is a non-transitory computer-readable storage medium that corresponds to the second aspect of the invention.

According to the first to third aspects of the invention, in the case where while the vehicle is traveling, the power source (engine) stops and an ECU that detects the vehicle speed is not supplied with electric power, it can be determined whether the vehicle is traveling. Furthermore, if it is determined that the vehicle is traveling, the restarting of the engine can be immediately prompted.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a block diagram showing a vehicle's travel state determination apparatus in accordance with an embodiment of the invention; and

FIG. 2 is a flowchart showing a content of a control of the vehicle's travel state determination apparatus of the embodiment.

### DETAILED DESCRIPTION OF EMBODIMENTS

Embodiments of the invention will be described hereinafter with reference to the accompanying drawings.

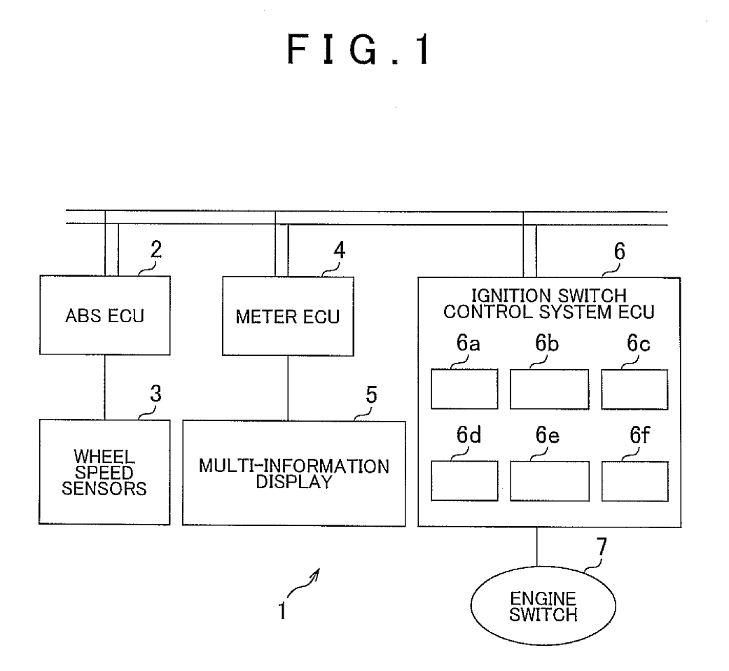

As shown in FIG. 1, a vehicle's travel state determination apparatus 1 of an embodiment includes an antilock brake system electronic control unit (ABSECU) 2, wheel speed sensors 3, a meter ECU 4, a multi-information display 5, an ignition switch (ignition switch) control system ECU 6 and an engine switch 7.

The ABSECU 2, the meter ECU 4 and the ignition switch control system ECU 6 are connected to one another by a communication protocol, for example, the CAN (controller area network) protocol or the like. Instead of the CAN protocol, it is possible to use other communication protocols such as LIN (local interconnect network), MOST (media oriented systems transport), FlexRay, etc.

The ABSECU 2 is constructed of a CPU (central processing unit), a ROM (read-only memory), a RAM (random access memory), a data bus that interconnects those components, and input/output interfaces. The CPU of the ABSECU 2 performs is predetermined processes described below, following programs stored in the ROM. The ABSECU 2 computes a vehicle speed signal on the basis of wheel speed signals from the wheel speed sensors 3 provided corresponding to the driven and driving wheels of the vehicle or corresponding to each of all the four wheels, and sends the computed vehicle speed signal onto the CAN.

The hardware construction of the meter ECU 4 is similar to that of the ABSECU 2. The meter ECU 4 receives the vehicle speed signal sent out by the ABSECU 2, and displays the vehicle speed in a speedometer (not shown) provided in a meter unit or in a speedometer provided in the screen of the multi-information display 5.

The multi-information display 5 is disposed at a position that is visible to a driver of the vehicle (e.g., in the meter unit, an instrument panel, a dashboard, etc.) or the like, and displays information commensurate with the signal from the meter ECU 4.

The hardware construction of the ignition switch control system ECU 6 is also similar to that of the ABSECU 2. The ignition switch control system ECU 6 includes a vehicle speed detection portion 6a, an engine stop determination portion 6b, a measurement portion 6c, a travel state determination portion 6d, a braking determination portion 6e and a display portion 6f.

The engine switch 7 is, for example, a push switch, and is installed at a driver side of the instrument panel. The engine switch 7 detects a depressing operation, and sends to the ignition switch control system ECU 6 information as to which one of an ignition-off state, an accessory (ACC) state or an ignition-on state the electric power supply state ought to be caused to be. Furthermore, the engine switch 7 detects a long-press operation (e.g., a press that continues for about 3 seconds or longer), and sends engine start information to the ignition switch control system ECU 6 so that an engine (not shown) will be started. In the case where the engine is stopped via the engine switch 7, the electric power supply state becomes the ACC state.

It is to be noted that to start the engine during a stop of the vehicle, the engine switch 7 is long pressed with the shift lever placed in the parking range, and that to start the engine while the vehicle is traveling, the engine switch 7 is long pressed with the shift lever placed in the neutral range. Furthermore, to stop the engine during the traveling of the vehicle, the engine switch 7 is simply long pressed.

The vehicle speed detection portion 6a receives the vehicle speed signal from the meter ECU 4 to detect the vehicle speed V. The engine stop determination portion 6b determines whether the vehicle speed V is a positive value and the ACC state of the electric power supply, that is, an engine stopped state, has been selected via the engine switch 7. The measurement portion 6c measures an elapsed time Tp from the time point at which the engine stop determination portion 6b determines that the vehicle is in the engine stopped state to the present time point, and also measures an engine stop-time vehicle speed VACC that is the vehicle speed V occurring when the engine stop determination portion 6b determines that the engine stopped state is present. The travel state determination portion 6d performs travel state determination as to whether the vehicle is traveling or has stopped on the basis of the engine stop-time vehicle speed VACC.

The travel state determination is performed separately depending on whether the vehicle is performing braking or not performing braking. The braking determination portion 6e determines whether braking is being performed in the vehicle by a braking apparatus, for example, on the basis of a braking signal from the ABSECU 2. It is to be noted that the braking signal may be separately input to the ignition switch control system ECU 6, for example, from a stop lamp switch or the like.

If it is determined by the braking determination portion 6e that braking is being performed, the travel state determination portion 6d performs the travel state determination on the basis of the engine stop-time vehicle speed VACC, an assumed maximum deceleration α that is assumed to be maximum regarding the vehicle (e.g., 0.5 G, which is a deceleration corresponding to hard braking that is a braking operation performed by the driver fully depressing the brake pedal) and the elapsed time Tp. That is, the vehicle's stopping time Tstop1=the engine stop-time vehicle speed VACC/deceleration α is computed as a threshold value, and then if the elapsed time Tp>the vehicle's stopping time Tstop1, it is determined that the vehicle is in the stopped state, and, if the elapsed time Tp≦the vehicle's stopping time Tstop1, it is determined that the vehicle is traveling.

If the braking determination portion 6e determines that braking is not being performed in the vehicle, the travel state determination is performed on the basis of the engine stop-time vehicle speed VACC, an assumed minimum deceleration β that is assumed to be minimum regarding the vehicle (e.g., a deceleration found by a vehicle traveling test involving the free running and inertia running of the vehicle) and the elapsed time Tp. That is, the vehicle's stopping time Tstop2=the engine stop-time vehicle speed VACC/deceleration β is computed as a threshold value, and then if the elapsed time Tp>the vehicle's stopping time Tstop2, it is determined that the vehicle is in the stopped state, and if the elapsed time Tp≦the vehicle's stopping time Tstop2, it is determined that the vehicle is traveling.

If it is determined by the travel state determination portion 6d that the vehicle is traveling, the display portion 6f sends to the meter ECU 4 a display request to display a content that prompts the driver to start the engine. On the basis of this display request, the meter ECU 4 displays, for example, a text that includes a message that says “To restart the engine when the vehicle is in motion, please select the neutral range and long press the engine switch 7.” in the screen of the multi-information display 5.

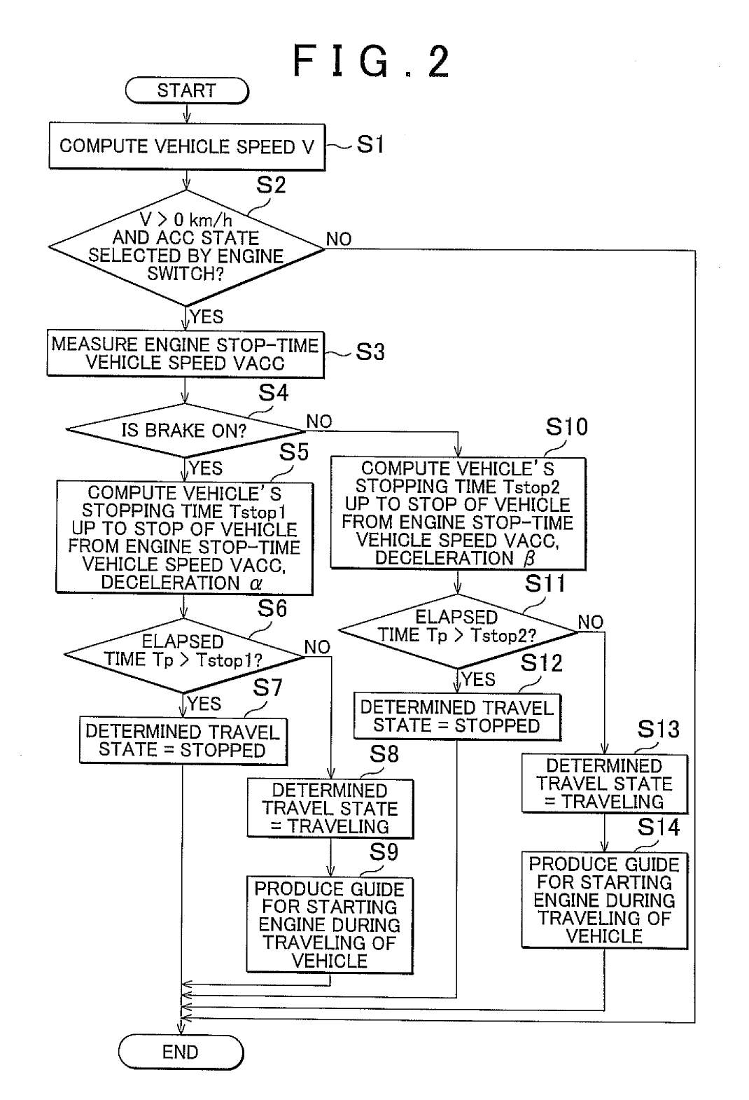

Hereinafter, a content of a control performed by the vehicle's travel state determination apparatus 1 in the embodiment will be described with reference to a flowchart shown in FIG. 2.

Firstly, the vehicle speed detection portion 6a acquires via the meter ECU 4 a vehicle speed signal that the ABSECU 2 computes from the wheel speed signals obtained from the wheel speed sensors 3, and thus detects the vehicle speed V (step S1).

Next, the engine stop determination portion 6b determines whether the vehicle speed V is larger than 0 km/h, that is, is a positive value, and the ACC state (engine stopped state) has been selected by the engine switch 7. If the engine is in the stopped state, the process proceeds to step S3. If the engine is not in the stopped state, the process ends.

In step S3, the measurement portion 6c, using as a reference the time at which it is determined in step S2 that the engine is in the stopped state, measures the engine stop-time vehicle speed VACC that is the vehicle speed V occurring at the time of determination of the engine stopped state. Next, the braking determination portion 6e determines whether braking is being performed on the basis of the braking signal from the ABSECU 2. If braking is being performed, the process proceeds to step S5, and if not, the process proceeds to step S10 (step S4).

In step S5, the travel state determination portion 6d computes a vehicle's stopping time Tstop1 that is needed before the vehicle stops at the time of braking, on the basis of the division of the engine stop-time vehicle speed VACC by the assumed maximum deceleration α. Next, the travel state determination portion Gd compares the vehicle's stopping time Tstop1 and the elapsed time Tp obtained from the measurement portion 6c, and determines whether the elapsed time Tp>the vehicle's stopping time Tstop1 is satisfied. If an affirmative determination is made, the process proceeds to step S7, and if a negative determination is made, the process proceeds to step S8 (step S6).

In step S7, the travel state determination portion 6d determines that the vehicle is in the stopped state. In step S8, it is determined that the vehicle is traveling. Next, the display portion 6f displays the message that prompts the restarting of the engine during the traveling of the vehicle in the screen of the multi-information display 5 via the meter ECU 4 (step S9).

In step S10, the travel state determination portion 6d computes the vehicle's stopping lime Tstop2 that is needed before the vehicle in the free running state or the inertia running state comes to a stop, on the basis of the division of the engine stop-time vehicle speed VACC by the assumed minimum deceleration β. It is to be noted that the relation of the vehicle's stopping time Tstop2>Tstop1 holds. Next, the travel state determination portion 6d compares the vehicle's stopping time Tstop2 and the elapsed time Tp obtained from the measurement portion 6c, and determines whether the relation of the elapsed time Tp>the vehicle's stopping time Tstop2 holds. If an affirmative determination is made, the process proceeds to step S12, and if a negative determination is made, the process proceeds to step S13 (step S11).

Next, the travel state determination portion 6d determines the travel state of the vehicle as being the stopped state in which the vehicle has stopped. In step S13, the travel state determination portion 6d determines the travel state of the vehicle as being the state in which the vehicle is traveling. Next, the display portion 6f displays the message that prompts the restarting of the engine during the traveling of the vehicle in the screen of the multi-information display 5 via the meter ECU 4 (step S14).

It is to be noted that the process from step S1 to step S14, that is, from the start to the end, is repeatedly executed at every processing cycle of the ignition switch control system ECU 6.

According to the control content described above, effects as stated below can be attained. That is, in both the case where a driver intentionally stops the engine via the engine switch 7 as an inconvenience occurs while the vehicle is traveling and the case where a driver erroneously operates the engine switch 7 so that the engine stops, the travel state of the vehicle can be estimated even if information about the vehicle speed cannot be obtained, and therefore the restarting of the engine can be prompted on the basis of the estimation of the travel state of the vehicle.

On the basis of the displayed prompt, the driver can quickly perform the restarting of the engine. In particular, the starting of the engine while the vehicle is traveling needs to be carried out with the neutral range selected. According to this embodiment, the incidents in which this engine restarting operation being different from the engine restarting operation performed during a stop of the vehicle makes it difficult for a driver to quickly start the engine can be reduced.

According to the embodiment, different operations may be performed separately depending on whether braking is being performed or not being performed. If braking is being performed, the deceleration α is used to compute the vehicle's stopping time Tstop1. If braking is not being performed, the deceleration β is used to compute the vehicle's stopping time Tstop2. In either case, the vehicle's stopping time (Tstp1 or Tstop2) is found by dividing the engine stop-time vehicle speed VACC by the corresponding one of the decelerations (α or β), and then is compared with the elapsed time, so that it can easily be determined whether the vehicle has stopped (is in the stopped state) or is traveling.

The aforementioned inconveniences include a case where due to a certain malfunction or the like, the operability of the accelerator pedal temporarily deteriorates and there arises a need for the driver to temporarily stop the engine while the vehicle is traveling, and then to have the malfunction or the like corrected or fixed.

While the preferred embodiment of the invention has been described in detail, the invention is not restricted by the foregoing embodiment, but the foregoing embodiment can be carried out with various modifications or substitutions without departing from the scope of the invention.

Although in the foregoing embodiment, the different assumed decelerations are selectively used according to whether the braking operation is being performed or not and the vehicle's stopping time is computed by using the selected one of the assumed decelerations, this is not restrictive. For example, a fixed deceleration may be assumed regardless of the braking operation, and may be used to find the vehicle's stopping time. This cuts complicated computations, and therefore will reduce the computation load. Alternatively, a deceleration commensurate with the amount of brake operation is found, and is used as a basis for finding the vehicle's stopping time. In this case, the greater the deceleration, the shorter the vehicle's stopping time is, as in the foregoing embodiment. Due to this operation, the vehicle's stopping time commensurate with the actual deceleration of the vehicle can be found, so that the accuracy of the computed vehicle's stopping time will improve.

In the foregoing embodiment, the travel state determination portion 6d performs both the function of finding the vehicle's stopping time that is a threshold value for determining the travel state of the vehicle on the basis of the vehicle speed information and the deceleration information (steps S5 and S10) and the function of determining the travel state of the vehicle by comparing the vehicle's stopping time and the elapsed time from the time point of the stop of the engine to the present time point (steps S6 and S11). However, this is not restrictive. For example, a portion that carries out the function of performing the process up to the output of a threshold value (stopping time) based on the vehicle speed information may be provided as a threshold value output portion separately from the travel state determination portion 6d, and the travel state determination portion 6d may determine the travel state of the vehicle on the basis of the threshold value obtained from the threshold value output portion and the elapsed time from the engine stop time point to the present time point.

Although the above embodiment is described in conjunction with an example of an engine starting method in which a message that prompts the restarting of the vehicle is displayed as a text, this message may be replaced by or accompanied by, for example, notification via a lamp provided with an appropriate combination of characters, such as “N” indicating the neutral range and “PUSH” indicating a long press on the engine switch 7, or the like.

Furthermore, although in the foregoing embodiment, the invention is applied to an automatic transmission vehicle equipped with the engine switch 7, the invention is also applicable to a manual transmission vehicle equipped with the engine switch 7. In that case, the starting of the engine is performed together with an operation of depressing the clutch pedal. Therefore, the message that prompts the restarting of the engine may be, for example, a message that says “If the vehicle is in motion, please long press the engine switch while depressing the clutch pedal.”.

According to the invention, in the case where while the vehicle is traveling, the engine is stopped by operating the engine switch 7, it is possible to more accurately determine whether the vehicle is traveling or has stopped, even in a situation where the electric power supply state has become the ACC state and therefore information regarding the vehicle speed cannot be acquired, and therefore to prompt the starting of the engine if the vehicle is traveling. Therefore, the invention is useful when applied to various vehicles, such as passenger automobiles, trucks, busses, etc., whose engine can be stopped during traveling.

What is claimed is:

1. A vehicle's travel state determination apparatus comprising:
a vehicle speed detection portion that detects speed of the vehicle and outputs speed information;
a threshold value output portion that outputs a threshold value based on the speed information;
a power source stop detection portion that detects a stop of a power source of the vehicle and outputs power source stop information; and
a travel state determination portion that determines a travel state of the vehicle based on the power source stop information and the threshold value, wherein
the travel state of the vehicle is determined based on the threshold value and an elapsed time that follows output of the power source stop information.

2. The vehicle's travel state determination apparatus according to claim 1, further comprising
a braking determination portion that determines whether braking is being performed in the vehicle, wherein
if it is determined by the braking determination portion that the braking is not being performed, the threshold value output portion computes the threshold value based on a deceleration that is assumed to be minimum regarding the vehicle.

3. The vehicle's travel state determination apparatus according to claim 1, further comprising
a braking determination portion that determines whether braking is being performed in the vehicle, wherein
if it is determined by the braking determination portion that the braking is being performed; the threshold value output portion computes the threshold value based on a deceleration that is assumed to be maximum regarding the vehicle.

4. The vehicle's travel state determination apparatus according to claim 1, further comprising
a decelerating state detection portion that detects a decelerating state of the vehicle, wherein
the threshold value output portion outputs the threshold value that is based on the speed information and a deceleration that corresponds to the decelerating state.

5. The vehicle's travel state determination apparatus according to claim 4, wherein
the decelerating state detection portion computes the threshold value so that the threshold value decreases as the deceleration increases, and outputs the threshold.

6. The vehicle's travel state determination apparatus according to claim 1, further comprising
a display portion that displays predetermined information based on information obtained from the travel state determination portion, wherein:
the travel state determination portion determines whether the vehicle is traveling; and
the display portion displays how to start the power source, if it is determined by the travel state determination portion that the vehicle is traveling.

7. A vehicle's travel state determination method comprising:
detecting speed of the vehicle;
outputting a threshold value based on the speed;
detecting that a power source of the vehicle is in a stopped state; and
performing travel state determination as to whether the vehicle is traveling, based on the threshold value and an elapsed time that follows a time point at which the stopped state of the power source is detected.

8. The vehicle's travel state determination method according to claim 7, further comprising displaying how to start the power source, if it is determined that the vehicle is traveling.

9. A non-transitory computer-readable storage medium that stops a program for executing the vehicle's travel state determination method according to claim 7.
